(19) United States
(12) Patent Application Publication
(10) Pub. No.: US 2006/0203715 A1
(43) Pub. Date: Sep. 14, 2006

(54) Method for redirection of virtual LAN network traffic

(75) Inventors: Steven Wade Hunter, Raleigh, NC (US); Norman Clark Strole, Raleigh, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/079,330

(22) Filed: Mar. 14, 2005

(51) Int. Cl. G06F 11/00

(52) U.S. Cl. 370/216

(57) ABSTRACT

A method and system to quickly redirect traffic from a server blade to different access switches that provide data communication to a network is presented. Each access switch has external ports directed upstream towards the network, and correlated internal ports directed downstream towards the server blade. The server blade has a primary upstream interface associated with a first access switch and a secondary failover upstream interface associated with a second access switch. In the event that the first access switch loses an upstream data signal or connection to one of its upstream external ports, a VLAN-determined corresponding downstream internal port in the first access switch is disabled, thus causing the primary upstream interface in the server blade to failover to the secondary failover upstream interface and its associated second access switch.

### CROSS-REFERENCE TO RELATED APPLICATIONS

The present application is related to the following co-pending U.S. patent application filed on even date herewith, and incorporated herein by reference in its entirety: Ser. No. 10/______, (RPS920050011US1), entitled “NETWORK SWITCH LINK FAILOVER IN A REDUNDANT SWITCH CONFIGURATION.”

### BACKGROUND OF THE INVENTION

1. Technical Field

The present invention relates in general to the field of computers, and in particular to a multiple blade server housed in a server chassis. Still more particularly, the present invention relates to a method and system for rerouting data traffic to and from one of the server blades in the server chasses when an uplink is lost.

2. Description of the Related Art

Server blade computers offer high-density server boards (blades) in a single server blade chassis (blade center chassis). A typical server blade computer is illustrated in FIG. 1, identified as server blade chassis 102. Server blade chassis 102 includes multiple hot-swappable server blades 104a-n. There are typically seven or more server blades 104 in server blade chassis 102. Server blades 104 communicate with an external network 106 via an (typically Ethernet based) internal switching system 108 and one or more external switching systems 110.

As shown in FIG. 1, there may be two external switching systems 110a and 110b. If communication between the internal switching system 108 and the external switching system 110 should break down (e.g., external switching system 110a experiences a failure or is simply unplugged from internal switching system 108), the internal switching system 108 can direct data traffic to external switching system 110b. This re-routing of data is performed by logic within internal switching system 108, using a link management protocol such as the Spanning Tree Protocol (STP), which is part of the IEEE 802.1 standard for media access control bridges.

A major drawback of systems such as STP is that they are relatively slow, taking as long as 30-60 seconds to re-route the data. Such a delay may be unacceptable to some applications, and may result in packet loss or disruption of end-to-end sessions.

### SUMMARY OF THE INVENTION

The present invention, therefore, addresses the need for a method and system to quickly redirect traffic from a server blade to different access switches that provide data communication to a network. Each access switch has external ports directed upstream towards the network, and correlated internal ports directed downstream towards the server blade. The server blade has a primary upstream interface associated with a first access switch and a secondary failover upstream interface associated with a second access switch. In the event that the first access switch loses an upstream data signal or connection to one of its upstream external ports, one or more VLAN-determined corresponding downstream internal ports in the first access switch is disabled, thus causing the primary upstream interface in the server blade to failover to the secondary failover upstream interface and its associated second access switch.

The above, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts a prior art diagram of a prior server blade chassis coupled to a network;

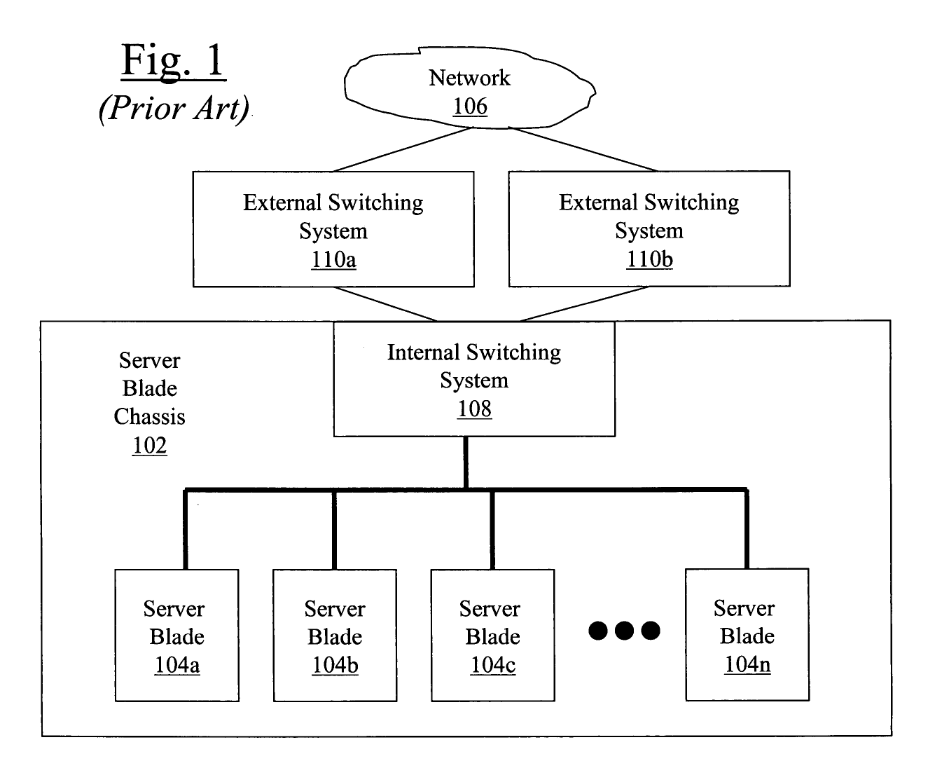

FIG. 2a illustrates dual Network Interfaced Cards (NICs) in a server blade in a server blade chassis;

FIG. 2b depicts a multiple layered switching pathway between server blades and the network via an Ethernet Switch Module (ESM);

FIG. 2c illustrates internal and external ports in the ESM shown in FIG. 2b;

FIG. 2d depicts a Virtual Local Area Network (VLAN) table for use by the ESM to determine which internal ports should be turned off in response to a specific external port being disconnected;

FIG. 2e shows an exemplary VLAN table as depicted in FIG. 2d, and

FIG. 3 is a flow-chart of steps taken in an exemplary embodiment of the present invention to disable internal ports in response to an external port being disconnected.

### DETAILED DESCRIPTION OF A PREFERRED EMBODIMENT

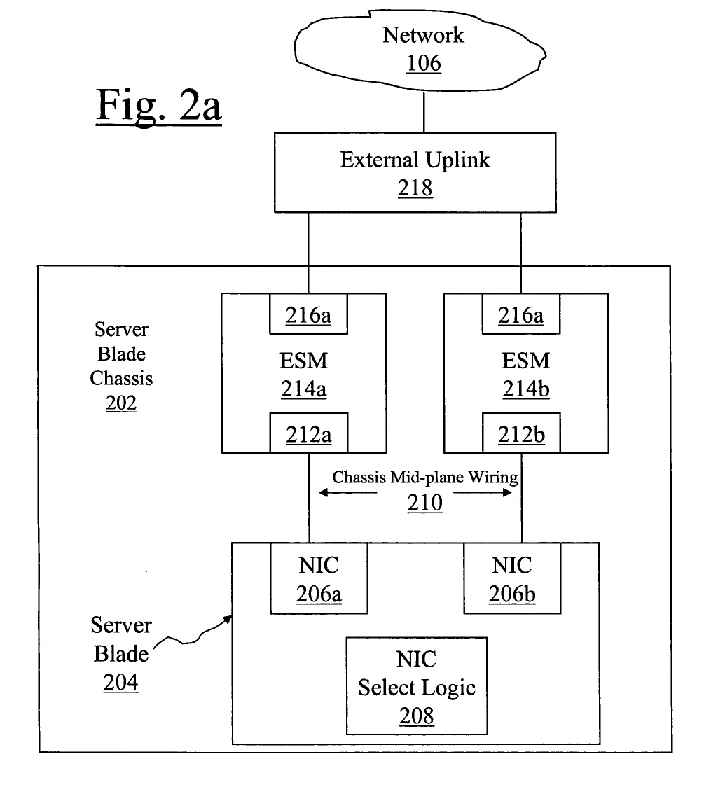

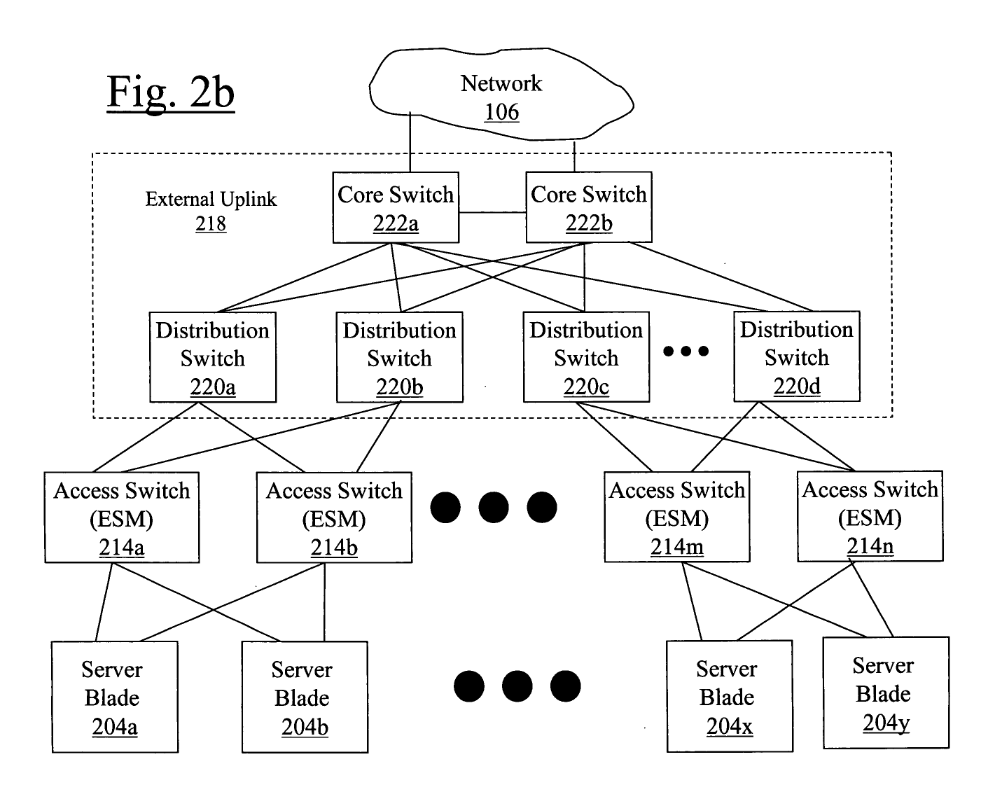

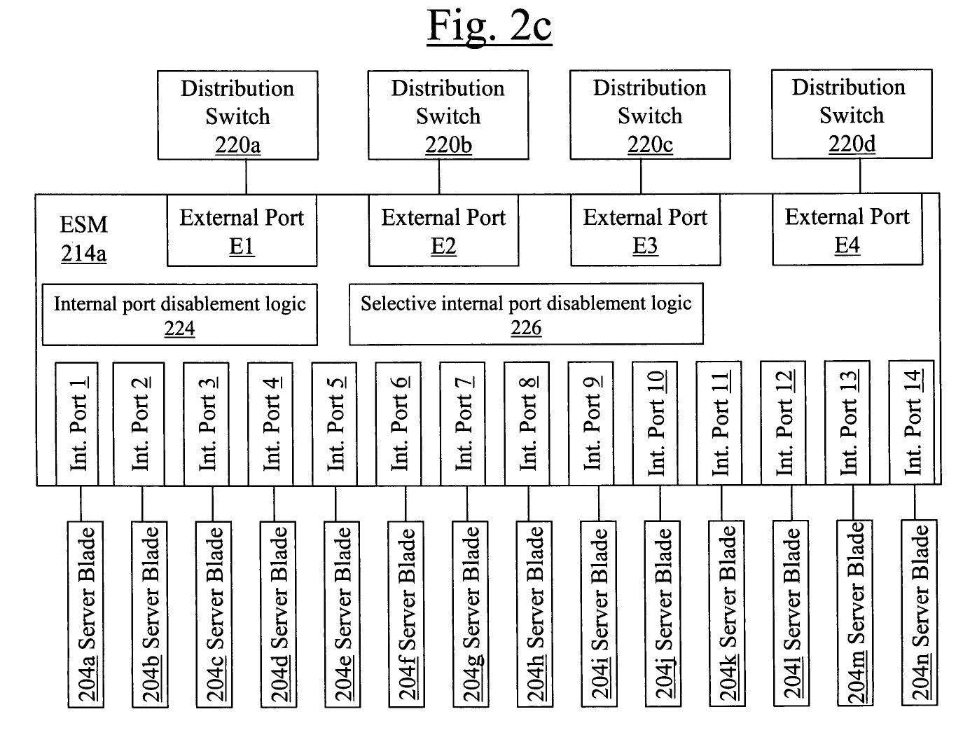

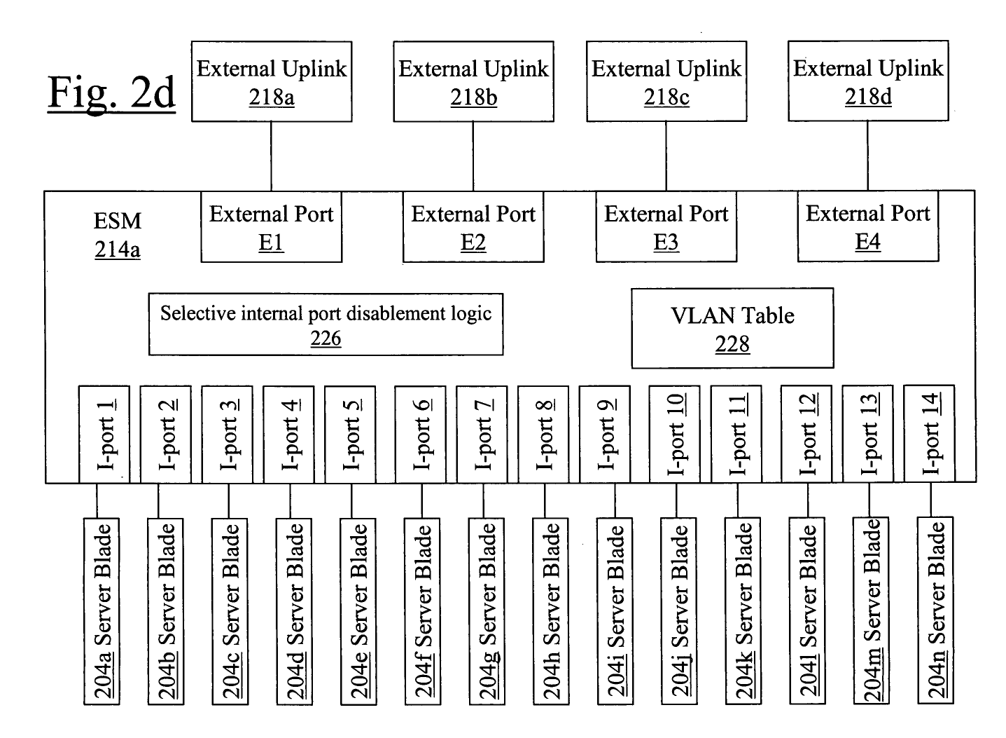

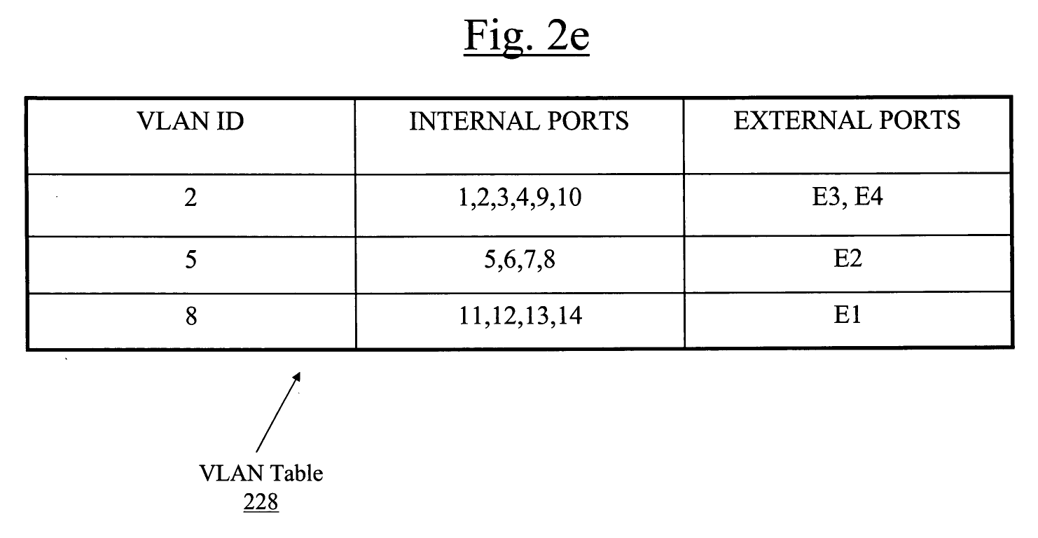

With reference now to FIG. 2a, there is depicted a schematic block diagram of a server blade chassis 202 according to a preferred embodiment of the present invention. For the sake of clarity, only one server blade 204 is depicted. However, in a preferred embodiment, server blade chassis 200 has a midplane (not shown) capable of connecting fourteen or more server blades 204.

Server blade 204 has multiple Network Interface Cards (NICs), shown in exemplary form as NIC 206a and NIC 206b. NICs 206 connect, preferably via chassis mid-plane wiring 210, to internal ports 212 in an Ethernet Switch Module (ESM) 214. As shown, each NIC 206 preferably connects to a different ESM 214. Each ESM 214 connects, via an external port 216, to an external uplink 218, which connects to the network 106.

NICs 206a and 206b are backups to each other. That is, if an upstream signal (from ESM 214a) is lost, then NIC 206a sendsa signal to a NIC select logic 208 (and/or alternatively to NIC 206b) instructing all data packets being communicated to and from server blade 204 to be routed via NIC 206b to ESM 214b. If and when upstream communication is re-established with NIC 206a, then NIC 206a sends a signal to NIC select logic 208 (and/orNIC 206b) that all future data packets to and from server blade 204 are to be again communicated via NIC 206a to ESM 214a.

With reference to ESM 214a in the example just described, assume that the link between external port 216a and external uplink 218 is broken. Such a link could be broken by a failure in external port 216a, a cable used to connect external port 216a and external uplink 218 could simply be inadvertently unplugged, or an uplink device such as external uplink 218 could fail due to being powered off, being defective, etc. In such a scenario in the prior art, NIC 206a would continue to communicate with internal port 212a, since the connection between NIC 206a and internal port 212a would still be intact, but data packets would not be able to reach external uplink 218. According to the present invention, however, the loss of the external port 216a connection results in internal port 212a being disabled, resulting in NIC 206a sensing no signal, to cause NIC 206b to take over.

Note that while in the preferred embodiment ESM 214a and ESM 214b are different intermediate switches, in an alternate embodiment they may be the same switch. If ESM 214a and 214b are the same switching unit, then NIC 206b is coupled to one or more internal (downstream/server blade facing) ports in the ESM 214 that are associated with a different external (upstream/network facing) port that has not lost its upstream data link. These internal and external ports are depicted in greater detail in FIGS. 2c-d below.

With reference now to FIG. 2b, an exemplary preferred switching scenario is depicted. Note that external uplink 218 may be comprised of two layers of switches: distribution switches 220 and core switches 222. Preferably, the switching scenario has two core switches 222, less than 10 distribution switches 220, and 20-30 access (ESM) switches 214. Thus, each higher (network facing) level is able to handle more switches found at a lower (server blade facing) level. In a preferred embodiment of the present invention, each switch (core switches 222, distribution switches 220, access (ESM) switches 214) is able to disable (turn off) an internal port (server blade facing) when an external port (network facing) no longer has communication with the next higher upstream switch or network.

Referring now to FIG. 2c, additional detail is shown for an ESM 214, and specifically for exemplary ESM 214a. While in a preferred embodiment each external port in ESM 214a may be logically and/or physically coupled to multiple upstream distribution switches 220, for exemplary purposes assume that ESM 214a has a different external port for each upstream distribution switch 220. For example, external port E1 is coupled only to distribution switch 220a, while external port E2 is coupled only to distribution switch 220b. In one preferred embodiment of the present invention, if a connection between any of the external ports E1-E4 and its corresponding distribution switch 220 is broken, then an Internal Port Disablement Logic 224 will disable all internal ports 1-14. By disabling all of the internal ports 1-14, then every server blade 204 will,cause communication to failover to its backup NIC 206, as described above.

In an alternative embodiment, however, rather than disabling all internal ports 1-14, only selected internal ports are disabled according to which internal port was carrying traffic to the disconnected external port. As shown in FIG. 2c, ESM 214a is depicted with a Selective Internal Port Disablement Logic (SIPDL) 226. SIPDL 226 contains logic that correlates which internal ports are being serviced by a particular external port. For example, assume that external port E1 handles traffic for internal ports 11, 12, 13 and 14. If external port E1 goes down (due to a break in the link with distribution switch 220a), then SIPDL 226 disables only internal ports 11, 12, 13 and 14, resulting in server blades 204k, l, m and n having their NICs failover as described above.

In another preferred embodiment, determining which internal port is associated with a particular external port is done with the aid of a Virtual Local Area Network (VLAN) table 228, as shown in FIGS. 2d-e. As is known and understood by those skilled in the art of networks, connections can be virtualized using software. Thus, rather than limiting connections to physical connections, the connections can be virtualized in software, such that an appearance is given to a system that there are more or less connection ports that physically exist. These virtual connections define virtual channels, which can be grouped together as trunks. These virtual trunks are referred to as VLAN trunks. The configuration of these virtual channels and their associated ports (and switches) can be performed at initial setup as well as dynamically during operation of the system. Thus, the internal and external ports described above are associated with each virtual channel on the fly.

The alternate embodiment reference in FIGS. 2d-e thus use the VLAN table 228 to correlate which virtual channel (or trunk) is using particular internal and external ports in the ESM 214, thus providing the ESM 214 information used to disable specified internal ports. Consider now the following exemplary scenario.

When a data packet is received in the ESM 214, the ESM 214 reads a tag in a header of the data packet, which tells the ESM 214 which external port should receive the data packet. With reference then to FIG. 2d, when a data packet is received by the ESM 214, the SIPDL 226 consults the VLAN table 228, as depicted in exemplary manner in FIG. 2e. VLAN table 228 notes that all channels in VLAN “8” are using internal ports 11-14, which uses external port E1. Therefore, if communication between external port E1 and distribution switch 220a is disrupted, then only internal ports 11-14 are disabled, since these are the internal ports through which VLAN “8” communicates.

Using the VLAN table 228 allows internal ports to be selectively disabled, just as described in the system of FIG. 2c, but using the VLAN table 228 allows the system to be more dynamic, since VLAN ID's can be reconfigured to be associated with different internal and external ports. For example, VLAN ID “8” can by dynamically (or initially) reconfigured to handle traffic from internal ports 5 and 8 instead of 11-14, while still sending traffic from VLAN ID “8” to external port E1. Alternatively, VLAN ID “8” can be reconfigured to still be associated with internal ports 11-14, but to direct packets from VLAN ID “8” to external port E2. That is, VLAN ID “8” can be reconfigured, preferably by SIPDL 226, to change both the internal ports and external ports associated with VLAN ID “8.”

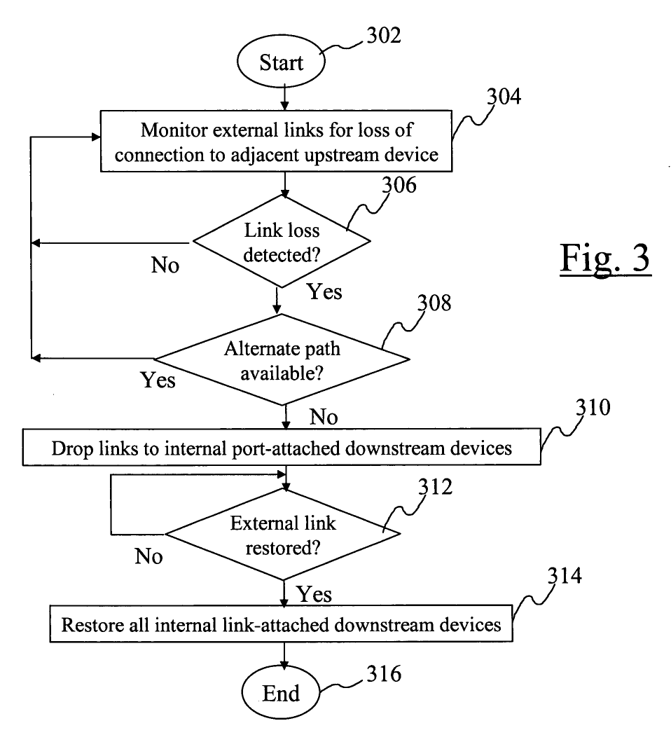

Referring now to FIG. 3, a flow-chart of exemplary steps taken by the present invention is presented. After initiator block 302, the external links in the ESM 214 are monitored (block 304) for a loss of connection to an adjacent upstream device, such as external uplink 218 described in FIG. 2b. If an upstream link loss is detected (query block 306), then a query is made as to whether an alternate path is available (query block 308). This alternate pathway may be provided by the Spanning Tree Protocol (STP) described above. Note, however, that optionally a time limit may be imposed describing how much time the STP is allowed to take to complete before disabling the internal links. That is, in one embodiment, if the ESM is STP enabled but the STP is not executed within a specified amount of time, then the ESM will forego the use of STP, and immediately disable the internal ports as described above. Alternatively, if STP is available in the ESM, then the ESM may wait until the STP operation is completed in the ESM up to the pre-determined time limit, in order to allow the data that is already in a buffer in the ESM to be transmitted to the external uplink. After this data is transmitted with the use of the STP, then the ESM disables the appropriate internal port, causing the downstream server blade to failover into the backup NIC.

As described in block 310, the internal ports are disabled, causing the internal port-attached downstream devices to be disconnected. If and when the ESM detects that the original external port is again in communication with the external uplink (query block 312), then the internal ports are again enabled for connection with the downstream devices (server blades).

Note that while the present invention has been described as operating within an ESM, it can also be implemented (exclusively or concurrently) in the other switches shown in FIG. 2b. That is, any intermediate switch having internal and external ports can use the present invention as described to disable downstream internal ports in response to detecting a break in a link with an upstream device.

While the present invention has been described as implicitly causing NIC failover, this can be explicitly caused as well. That is, as described above, the back-up failover NIC in the server blade is activated when it receives a signal indicating a loss of communication between the primary NIC and the upstream link. This signal may be in the form of a message in a packet, such as in a header of a data packet being directed to the primary NIC in the computer system, or the signal may be an electrical signal on a pathway (such as setting a line to the computer system high or low). This signal, whether in the packet header or on a line as described, is defined as an encoded message, which instructs the primary NIC to failover to the backup NIC.

Thus, the upstream link can send the encoded message directly to either the primary or backup NIC, telling them that the primary NIC's upstream pathway has been broken. Similarly, while the system has been described for exemplary purposes as using NIC's, any similar such interface device may be used in accordance with the present invention.

While the ports have been described as being “external” and “internal,” it should be understood that these terms are used to describe the respective “upstream” and “downstream” characteristics of these ports. Thus, a reference to an “upstream” port is understood in a preferred embodiment as being towards a network, and a reference to a “downstream” port is understood in the preferred embodiment as being towards a processor.

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A system comprising:
an external uplink coupled to a network;
a first intermediate switch coupled to the external uplink via at least one upstream port in the intermediate switch; and
a computer processor coupled to the access switch via at least one downstream port in the intermediate switch, wherein, upon a detection of a communication break between the external uplink and an upstream port in the first intermediate switch, the at least one downstream port that is associated with the external uplink, as determined by a Virtual Local Area Network (VLAN) table, is disabled.

2. The system of claim 1, wherein each upstream port in the first intermediate switch is associated with one or more downstream ports in the first intermediate switch, and wherein the computer processor further comprises:
a first interface coupled to a first downstream port in the first intermediate switch; and
a second interface coupled to a second downstream port in a second intermediate switch, wherein a disabling of the first downstream port in the first intermediate switch causes the first interface of the computer processor to failover to the second interface of the computer processor, such that the second interface is able to communicate with a different upstream port in the second intermediate switch.

3. The system of claim 2, wherein the first and second interfaces in the computer processor are Network Interface Cards (NICs).

4. The system of claim 2, wherein the first and second intermediate switches are a same intermediate switch.

5. The system of claim 1, wherein all downstream ports in the first intermediate switch are disabled in response to an upstream communication link to the first intermediate switch being broken.

6. The system of claim 2, wherein the first intermediate switch sends an encoded message to a downstream device in response to an upstream link being broken, and wherein the encoded message instructs the first interface associated with the computer processor to failover to the second interface associated with the computer processor.

7. The system of claim 6, wherein the encoded message is found in a packet header sent to the first interface.

8. The system of claim 6, wherein the encoded message is an electrical signal that sets a line in the first interface to a logical level that instructs the first interface to failover to the second interface associated with the computer processor.

9. A method comprising:
coupling an external uplink to a network;
coupling a first intermediate switch to the external uplink via at least one upstream port in the intermediate switch;
coupling a computer processor to the access switch via at least one downstream port in the intermediate switch; and
in response to a detection of a communication break between the external uplink and the at least one upstream port in the first intermediate switch, disabling the at least one downstream port that is associated with the at least one upstream port, wherein an association of the at least one downstream port and the at least one upstream port in the intermediate switch is determined by a Virtual Local Area Network (VLAN) table that describes which internal ports in the first intermediate switch are associated with particular VLANs in the computer processor.

10. The method of claim 9, further comprising:
associating each upstream port in the first intermediate switch is with one or more downstream ports in the first intermediate switch;
coupling a first interface in the computer processor to a first downstream port in the first intermediate switch;
coupling a second interface in the computer processor to a second downstream port in a second intermediate switch; and
in response to a disabling of the first downstream port in the first intermediate switch, causing the first interface of the computer processor to failover to the second interface of the computer processor, such that the second interface is able to communicate with a different upstream port in the second intermediate switch.

11. The method of claim 10, wherein the first and second interfaces in the computer processor are Network Interface Cards (NICs).

12. The method of claim 10, wherein the first and second intermediate switches are a same intermediate switch.

13. The method of claim 9, wherein all downstream ports in the first intermediate switch are disabled in response to an upstream communication link to the first intermediate switch being broken.

14. The method of claim 9, wherein the first intermediate switch sends an encoded message to a downstream device in response to an upstream link being broken.

15. A computer program product, residing on a computer usable medium, comprising:
program code for coupling an external uplink to a network;
program code for coupling a first intermediate switch to the external uplink via at least one upstream port in the intermediate switch;
program code for coupling a computer processor to the access switch via at least one downstream port in the intermediate switch; and
program code for, in response to a detection of a communication break between the external uplink and the at least one upstream port in the first intermediate switch, disabling the at least one downstream port that is associated with the at least one upstream port, wherein an association of the at least one downstream port and the at least one upstream port in the intermediate switch is determined by a Virtual Local Area Network (VLAN) table that describes which internal ports in the first intermediate switch are associated with particular VLANs in the computer processor

16. The computer program product of claim 15, further comprising:
program code for associating each upstream port in the first intermediate switch is with one or more downstream ports in the first intermediate switch;
program code for coupling a first interface in the computer processor to a first downstream port in the first intermediate switch;
program code for coupling a second interface in the computer processor to a second downstream port in a second intermediate switch; and
program code for, in response to a disabling of the first downstream port in the first intermediate switch, causing the first interface of the computer processor to failover to the second interface of the computer processor, such that the second interface is able to communicate with a different upstream port in the second intermediate switch.

17. The computer program product of claim 16, wherein the first and second interfaces in the computer processor are Network Interface Cards (NICs).

18. The computer program product of claim 16, wherein the first and second intermediate switches are a same intermediate switch.

19. The computer program product of claim 15, wherein all downstream ports in the first intermediate switch are disabled in response to an upstream communication link to the first intermediate switch being broken.

20. The computer program product of claim 15, wherein the first intermediate switch sends an encoded message to a downstream device in response to an upstream link being broken.
